(19) United States
(12) Patent Application Publication
(10) Pub. No.: US 2013/0008822 A1
(43) Pub. Date: Jan. 10, 2013

(54) CONTAINER FOR COSMETIC POWDER

(75) Inventors: SAFI HEFETZ, TEL AVIV (IL); RAZ MOHEBAN, TEL AVIV (IL)

(73) Assignee: IL MAKIAGE LTD, TEL AVIV (IL)

(21) Appl. No.: 13/177,580

(22) Filed: Jul. 7, 2011

(51) Int. Cl. B65D 85/00; B23P 17/04

(52) U.S. Cl. 206/524.1; 29/428

(57) ABSTRACT

A container for a powdered cosmetic including a container body defining a reservoir for receiving loose powder, a strainer defining a powder collection surface, of smaller size than the container body, covering the reservoir, and a lid adapted and configured to define a powder receiving volume between the strainer and the lid, and at least one aperture around the powder collection surface for powder to fall from the strainer into the reservoir. Preferably, the strainer further includes at least one upstanding ridge for at least partially cleaning a brush or sponge applicator.

### FIELD OF THE INVENTION

The present invention relates to containers for powder, in general and, in particular, to a container for a loose cosmetic powder or dust.

### BACKGROUND OF THE INVENTION

Face powder is an important regimen in beauty essentials. 70% of women around the globe apply face powder before going out because powder is the easiest and fastest way to correct blemishes and makeup, and helps to make face makeup last. However, it is important not to apply too much powder, as it might create exaggerated fine lines. Typically, the user must tip the container and tap the bottom softly, so as to release the powder into the container's top section. Then, a powder puff or makeup brush is dipped into the powder and tapped against the powder container to remove excess powder before dusting the powder onto the face.

In recent years, eye shadow or highlighter has also been packaged as loose powder and is applied in the same fashion using a makeup brush or sponge applicator.

At present, containers for loose cosmetic powder include a reservoir of powder with an internal, planar strainer. The container is shaken, and a random, usually excess, amount of powder from the reservoir passes through the strainer and remains on it. Then, when the powder puff or makeup brush is dipped into the powder on the strainer, too much powder attaches to it and there is no good way to wipe it off. In addition, after a powder puff or makeup brush has removed the desired quantity of powder for application to the face, most of the remainder cannot be returned to the reservoir, so the excess powder typically is shaken off of the strainer out of the container and disposed of.

Accordingly, there is a long felt need for a container for a loose cosmetic powder which permits only a pre-determined quantity of powder to move from the reservoir to the top of the container, and enable return of any excess powder to the reservoir and would be very desirable if it included an element to wipe excess powder from the brush so that this excess powder can also return to the reservoir.

### SUMMARY OF THE INVENTION

The present invention relates to a container for a cosmetic powder to control the amount of powder extracted for use. The device includes a strainer having a powder collection surface thereon of a smaller size or diameter than the container itself. At least one and preferably a plurality of peripheral apertures are defined around the powder collection surface. A lid is provided to close the container. The lid and the strainer are configured to delimit a powder collection volume of a pre-defined size between them. According to some embodiments, the lid is complementary in shape to the strainer and is distanced a pre-selected distance from the strainer. The apertures or openings around the powder collection surface permit excess powder to return to the container or powder reservoir. Preferably, cleaning ridges are provided on the strainer for removing excess powder from a makeup brush before application.

According to some embodiments of the invention, the powder collection surface is raised and coupled to a mounting lip for mounting on the container body by at least one support member. According to one embodiment, a plurality of slanted support members are provided to support the powder collection surface.

There is thus provided, according to the present invention, a container for a powdered cosmetic including a container body defining a reservoir for receiving loose powder, a strainer defining a powder collection surface, of smaller size than the container body, covering the reservoir, and a lid adapted and configured to define a powder receiving volume between the strainer and the lid, and at least one aperture around the powder collection surface for powder to fall from the strainer into the reservoir.

According to a preferred embodiment, the lid has an internal shape complementary to that of the strainer and is distanced a pre-selected distance from the strainer.

According to a preferred embodiment, the strainer further includes at least one upstanding ridge for at least partially cleaning a brush or sponge applicator.

According to preferred embodiments, the powder collection surface includes apertures sized and distributed to retain a pre-defined quantity of powder on the surface, while the peripheral apertures are of larger size, to expedite flow of powder through the strainer.

Preferably, the lid includes an adjustment mechanism for adjusting said given volume. The adjustment mechanism may include an inner lid portion movably coupled to an outer lid portion for movement to the outer lid portion.

The present invention also provides a method for making a container for a powdered cosmetic. The method includes providing a container body forming a reservoir for receiving loose powder, closing the reservoir with a strainer defining a powder collection surface of smaller size than the container body, disposing a lid on the container body, distanced a pre-selected distance from the strainer so as to delimit a pre-defined volume therebetween, and forming at least one peripheral aperture through the strainer for powder to fall from the strainer into the reservoir.

Preferably, the method further includes forming at least one upstanding ridge on the strainer for partially cleaning a powder applicator.

### BRIEF DESCRIPTION OF THE DRAWINGS

The present invention will be further understood and appreciated from the following detailed description taken in conjunction with the drawings in which:

FIG. 1 is a partially cut-away perspective illustration of a container for loose powder, constructed and operative in accordance with one embodiment of the present invention, in a closed orientation;

FIG. 2 is a partially cut-away perspective illustration of the container according to FIG. 1, in an open orientation;

FIG. 3 is an exploded cut-away perspective view of the container of FIG. 1;

FIG. 4 is a top view of the strainer of the container of FIG. 1;

FIGS. 5a to 5d are top views of loose powder containers having strainers according to various embodiments of the invention; and

FIG. 6 is a sectional view of a container for loose powder, constructed and operative in accordance with an alternative embodiment of the present invention.

### DETAILED DESCRIPTION OF THE INVENTION

The present invention relates to a container for holding a cosmetic powder or dust. The container includes a reservoir for loose powder and a strainer or sieve for disposing in the container, covering the reservoir, to control the amount of powder extracted from the reservoir at one time for use. The strainer includes a powder collection surface of a smaller size or diameter than the container itself. At least one and preferably a plurality of peripheral apertures are defined around the powder collection surface. According to some embodiments, the powder collection surface is raised. In this case, typically the strainer has a cup-like shape and the powder collection surface is raised from the bottom of the cup by means of at least one support member, which may be slanted, defining a conical shaped support. The sides of the cup merge into a lip seating on the container body.

The container further includes a lid configured to define a powder collection space of pre-defined volume between the strainer and the lid. According to one embodiment, the lid has a shape complementary to the shape of the strainer. Thus, the combination of the container lid and the strainer controls the quantity of powder leaving the reservoir. One or more apertures are provided around the powder collection surface, particularly around the base of the strainer, or are defined between the support members, to permit excess powder to slide back into the powder reservoir. One or more cleaning ridges preferably are provided on the strainer for removing excess powder from a makeup brush before application to the face. The container is particularly suitable for loose powder, such as face powder, eye shadow and highlighter.

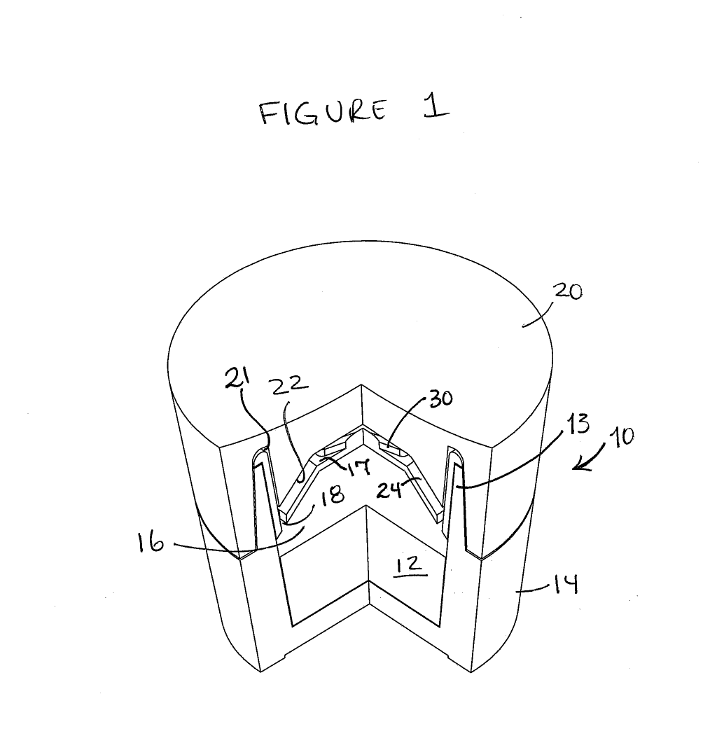

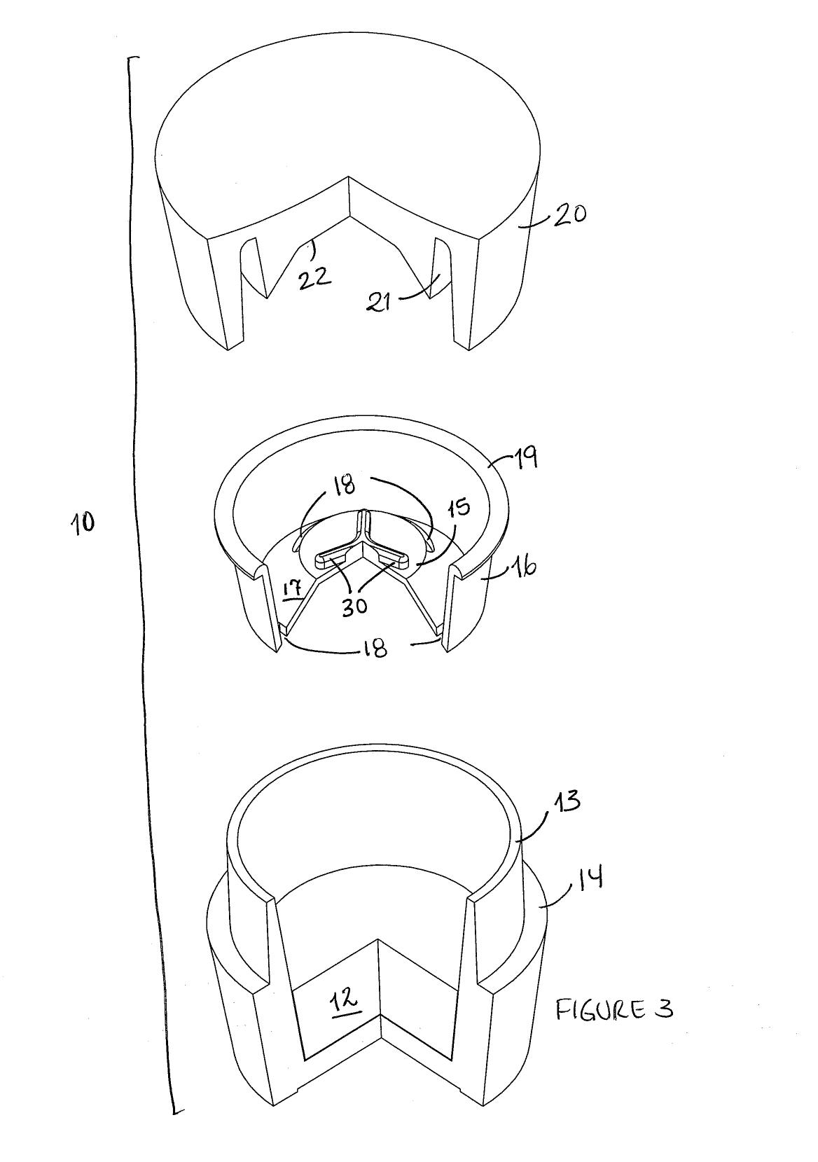

Referring now to FIGS. 1, 2 and 3, there are shown partially cut-away perspective illustrations of a container 10 for loose powder, constructed and operative in accordance with one embodiment of the present invention, in a closed orientation. Container 10 includes a reservoir 12 for loose powder in a container body 14 defining a recessed upper portion 13. A strainer 16 is mounted on container body 14 and covers reservoir 12. Strainer 16 may be integrally formed with the walls of the container body or may define a mounting lip 19 configured to seat on the container body. Strainer 16 includes a powder collection surface 15 supported by at least one support member 17. It will be appreciated that the surface of support member 17 also collects an amount of powder. In the illustrated embodiment, strainer 16 is cup-shaped and powder collection surface 15 is supported by an upwardly slanted support surface 17, shaped as a truncated cone.

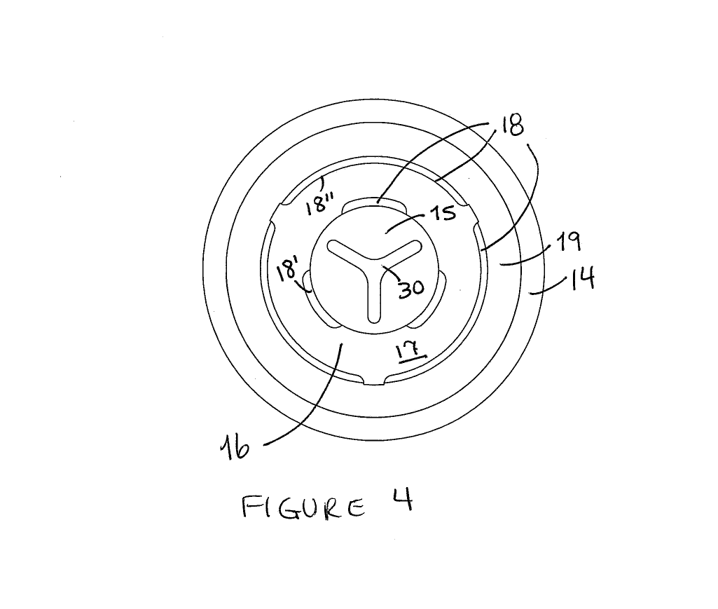

At least one, and preferably a plurality of apertures 18, 18′ are provided in strainer 16 to permit a two way flow of powder in the container. It will be appreciated that the powder collection surface preferably includes apertures 18 of relatively small size, to prevent clumping of powder as it leaves the reservoir, or may include no apertures at all, while peripheral apertures 18′ about the periphery of strainer 16 or between the support members may be of larger size, for rapid flow of powder back into the reservoir. One of an infinite number of possible arrangements is shown in FIG. 4. In this arrangement, three elongate, arcuate apertures 18 are provided about the powder collection surface near the top of strainer 16, while three additional elongate apertures 18′ are provided around the base of the strainer. Thus, powder from the reservoir can move from the reservoir onto the powder collection surface 15 of strainer 16 when the container is shaken gently or tilted on its side, and powder seated on the powder collection surface 15 and on the supporting members 17 can flow back through apertures 18′ into the reservoir when the container is held right-side up or tapped gently.

Referring again to FIGS. 1, 2 and 3, a lid 20 is provided for closing container 10 in any conventional manner, such as by means of complementary screw threads. In the illustrated embodiment, lid 20 includes an annular groove 21 configured to receive upper recessed portion 13 of the container body. In the illustrated embodiment, the lip 19 of the strainer is supported on the upper portion of the container body between the container body and groove 21. The internal surface 22 of lid 20 is configured to define a volume for collecting powder between surface 22 and the strainer 16 and may be distanced from the strainer by a predetermined distance. According to the illustrated embodiment, internal surface 22 has a shape complementary to the shape of strainer 16, although this is not required. The distance between surface 22 and strainer 16 is selected so as to delimit a pre-defined volume 24 between the strainer and the lid which, in turn, limits the quantity of powder that can leave the reservoir and sit on the strainer, as explained in detail below.

According to preferred embodiments of the invention, one or more upstanding ridges 30 are provided on the powder collection area 15 and/or on supporting member 17 of strainer 16. Ridges 30 permit a user to wipe excess powder off her brush or sponge, before applying the powder to her face, in such a way that the excess can fall back into the reservoir through apertures 18. In this embodiment, three ridges 30 extend radially from the center of the strainer, although any other shape, position or arrangement can be utilized.

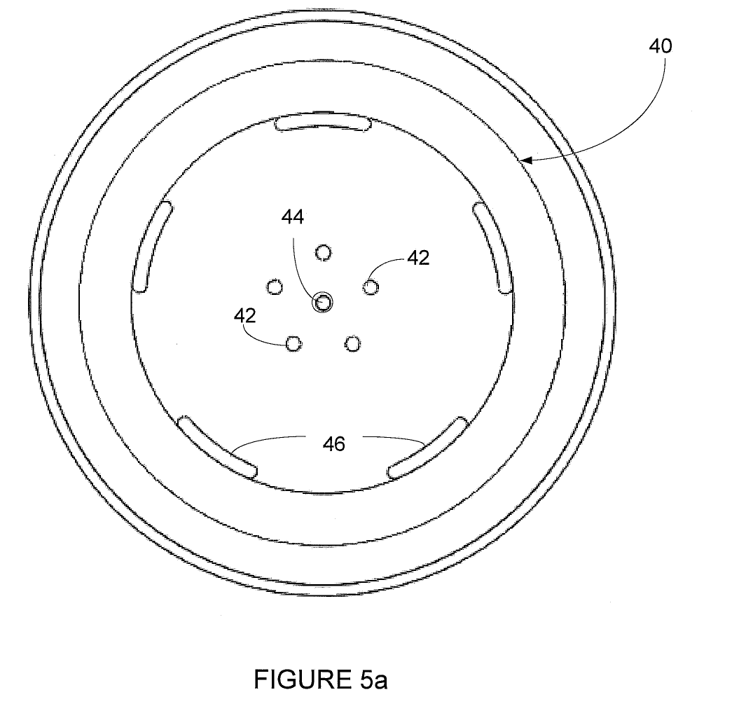

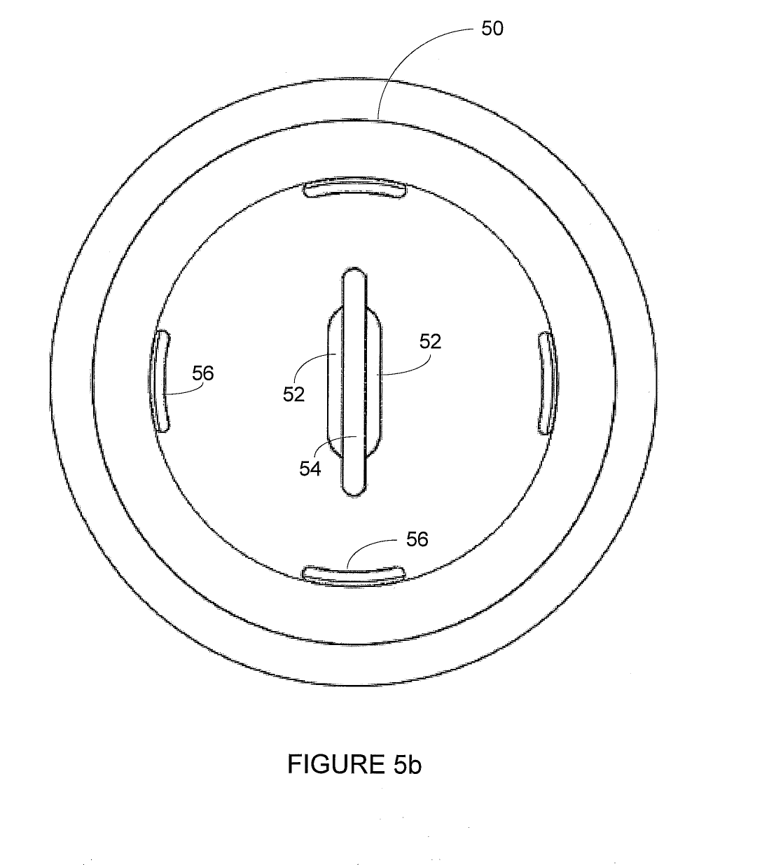

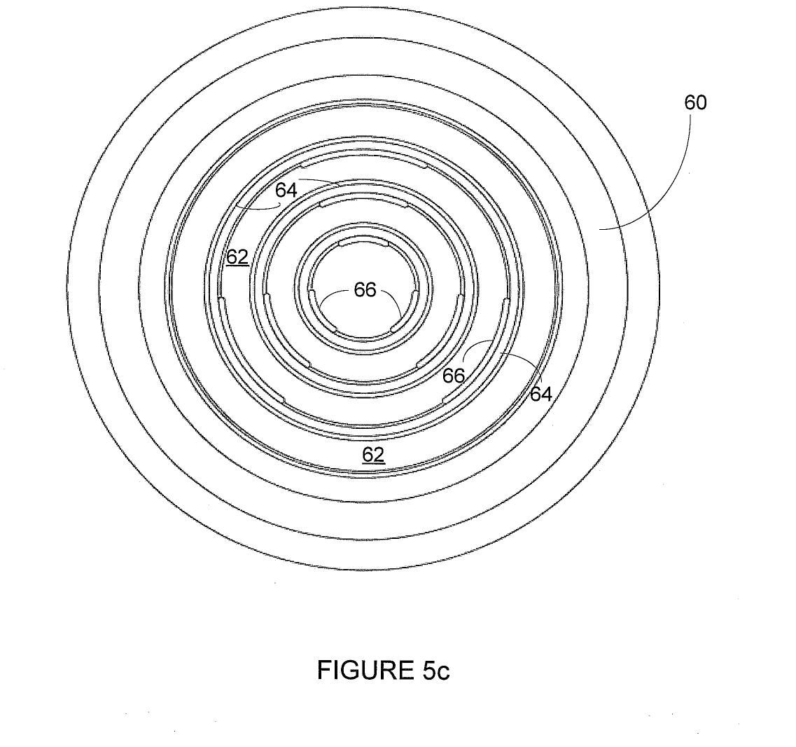

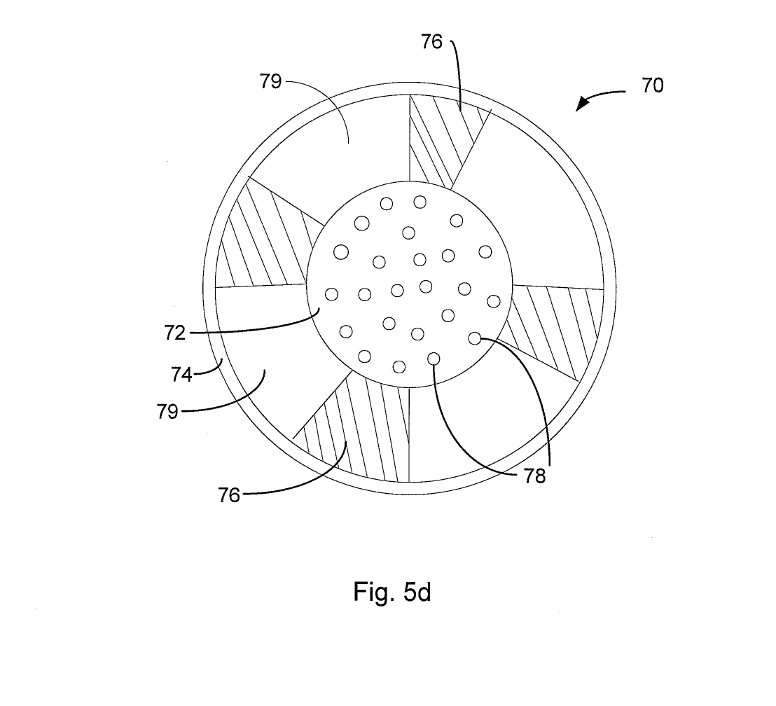

FIGS. 5a to 5d are top views of loose powder containers having strainer, aperture and ridge designs according to various embodiments of the invention. It will be appreciated however, that these embodiments are merely examples and, alternatively, any other arrangement can be utilized. Thus, in FIG. 5a, a conical strainer 40 is illustrated having a plurality of round apertures 42 around the apex. A central circular ridge 44 is provided for removing excess powder from an applicator, and a plurality of arcuate peripheral apertures 46 are provided at the base of strainer 40.

FIG. 5b shows a strainer 50 having a pair of linear apertures 52 along a linear central ridge 54 on the powder collection surface. A plurality of arcuate, peripheral apertures 56 are provided around the base of strainer 50.

FIG. 5c illustrates a strainer 60 formed of a plurality of concentric tiers or steps 62, each of smaller diameter than the tier below. Each tier includes an annular upstanding ridge 64. A plurality of arcuate apertures 66 are provided adjacent each ridge 64 on several or all of the tiers.

FIG. 5d is a top view of a strainer 70 for a loose powder container according to yet another embodiment of the invention. Strainer 70 includes a circular powder collection surface 72 coupled to an annular mounting lip 74 by a plurality of support members 76. Apertures 78 are provided in powder collection surface 72 for straining powder leaving the reservoir through the powder collection surface, and peripheral apertures 79 are defined between the support members 76 to permit movement of powder from the reservoir and expedite the flow of excess powder back into the reservoir. It will be appreciated that strainer 70 may be a planar strainer.

It will be appreciated that the embodiments illustrated herein show powder collection areas substantially circular. However, the powder collection area can alternatively be designed to have any shape.

It will be appreciated that the strainer includes two separate areas—a powder collection area and a peripheral area. The powder collection area serves as a work area from which the user takes the powder, and has apertures that are sized and located to permit the collection of more powder than on the support members. In particular, the powder collection area is configured to hold sufficient powder for the user to apply at one time. The peripheral area, on the other hand, includes apertures sized for expediting powder flow.

It will be appreciated that only a few of the many possibilities of design of the strainer have been provided for illustration only. Alternatively, any other combination of slanted or conical strainer with apertures permitting two-way flow of powder may be utilized.

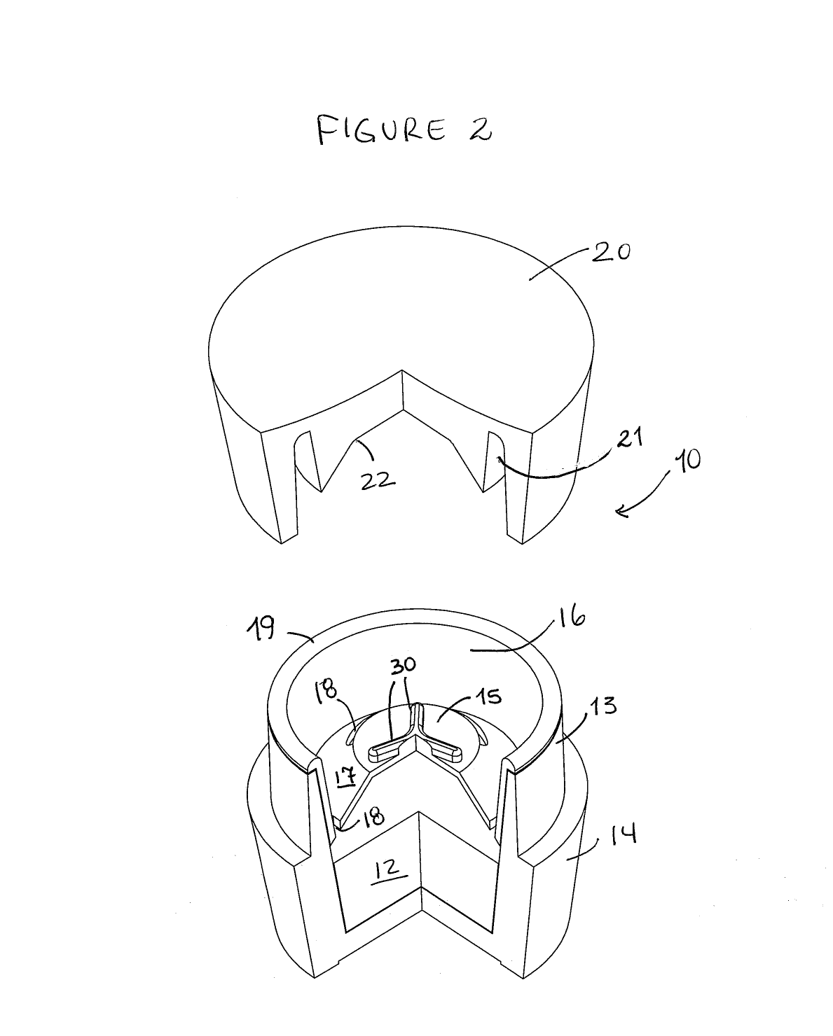

Operation of the container of the present invention is as follows, with further reference to FIGS. 1, 2 and 4. When a user wishes to use some of the powder in the container, the closed container seen in FIG. 1 is turned shaken gently. Loose powder from the reservoir 12 will flow through apertures 18 into the volume 24 defined between the top surface 17 of the strainer and the inner surface 22 of the lid 20. The user now opens lid 20, as shown in FIGS. 2 and 4, and collects an amount of powder on an applicator brush or sponge (not shown). The brush or sponge is wiped gently on ridges 30 and any excess powder falling off the applicator sits on or slides down top surface 17 of the strainer. The container can now be shaken gently, in either the open or closed orientation, causing the powder on top surface of strainer 16 to fall through apertures 18 back into the reservoir.

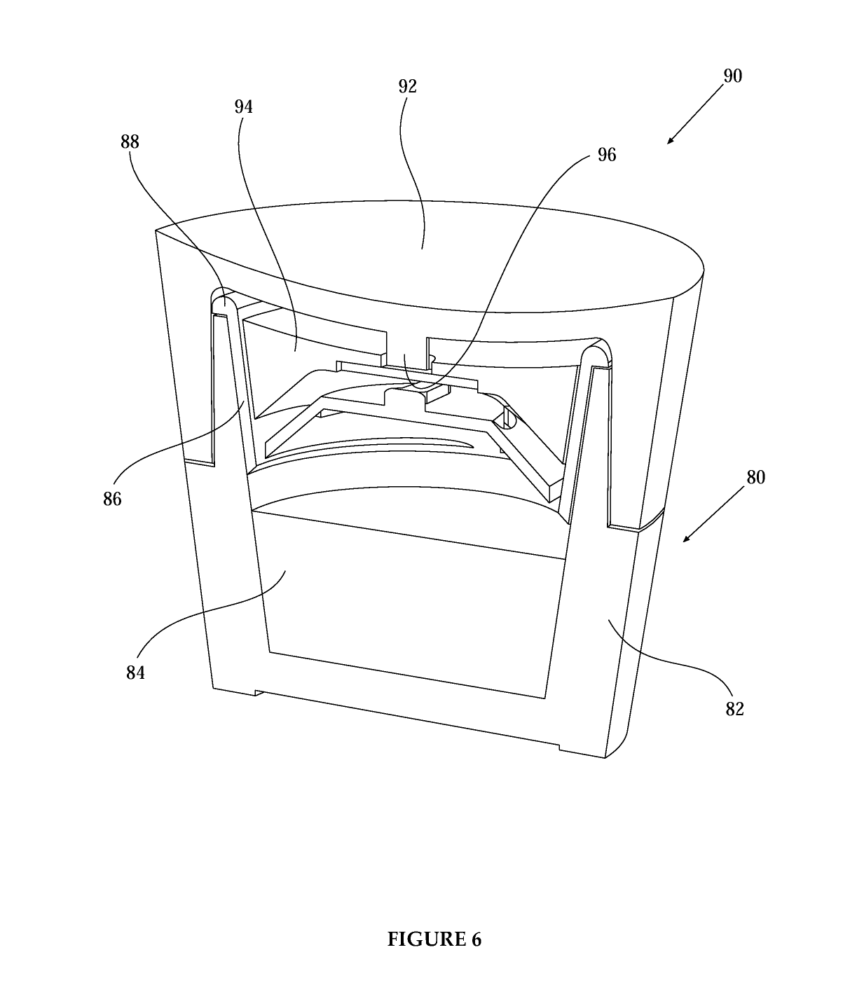

If it is desired to permit the user to change the volume of the powder collection area or the quantity of powder that can flow from the reservoir each time, this can be accomplished by providing a lid having an inner surface of adjustable size or shape. One example of such a lid 90 is illustrated in the container 80 of FIG. 6. Container 80 is substantially similar to container 10 of FIG. 1. Container 80 includes a container body 82 defining a reservoir 84. A strainer 86 having a lip 88 is seated on container body 82 and closes the reservoir 84.

Lid 90 includes an adjustment mechanism for adjusting the volume between the inner surface of the lid and the strainer, and is a two part lid. Lid 90 includes an outer lid 92, having screw threads (not shown) or other means for releasable mounting on the container body 82, and an inner lid portion 94 movable relative to the outer lid 92 and, thus, relative to strainer 86. For example, inner lid portion 94 may be coupled to outer lid 92 by means of a screw 96. When is it desired to change the distance between the inner lid and the strainer and, thereby, change the quantity of powder leaving the reservoir at one time, it is merely necessary to rotate the inner lid 94 about screw 96 in the appropriate direction. Alternatively, any other mechanism for permitting change of the size or shape of the lid may be utilized.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A container for a powdered cosmetic, the container comprising:
a container body defining a reservoir for receiving loose powder;
a strainer covering the reservoir, said strainer including a raised powder collection surface, of smaller size than the container body;
said powder collection surface sized to retain a pre-defined quantity of powder on said powder collection surface;
and
at least one peripheral aperture defined in said strainer, said peripheral aperture sized to guide powder from the powder collection surface back into the reservoir;
wherein said strainer further includes at least one upstanding ridge on said powder collection surface above said peripheral apertures for partially cleaning a powder applicator.

2. (canceled)

3. The container according to claim 2, wherein said strainer is conical in shape.

4. The container according to claim 1, wherein said strainer is an inverted cup shaped strainer with said powder collection surface coupled to a mounting lip by at least one slanting support member.

5. The container according to claim 1, further comprising a lid having a shape complementary to the shape of said strainer which is distanced a pre-selected distance therefrom.

6. The container of claim 1, wherein the powder collection surface further includes apertures sized and distributed to retain a pre-defined quantity of powder on the surface, while said peripheral apertures are of larger size, to expedite flow of powder through the strainer.

7. (canceled)

8. (canceled)

9. (canceled)

10. (canceled)

11. The container according to claim 1, wherein said lid includes an adjustment mechanism for adjusting said given volume.

12. The container according to claim 2, wherein said lid includes an adjustment mechanism for adjusting said given volume.

13. The container according to claim 6, wherein said lid includes an adjustment mechanism for adjusting said given volume.

14. The container according to claim 10, wherein said adjustment mechanism includes an inner lid portion movably coupled to an outer lid portion for movement to said outer lid portion.

15. A method for making a container for a powdered cosmetic, the method comprising:
providing a container body forming a reservoir for receiving loose powder;
closing said reservoir with a strainer including a raised powder collection surface of smaller size than the container body, said powder collection surface sized to retain a pre-defined quantity of powder on said powder collection surface;
forming at least one upstanding ridge on said powder collection surface above said peripheral apertures for partially cleaning a powder applicator; and
forming at least one peripheral aperture through the strainer below said upstanding ridge for guiding powder from the powder collection surface back into the reservoir.

16. (canceled)

17. (canceled)

18. (canceled)

19. The method according to claim 15, further comprising disposing a lid having an internal shape complementary to the shape of said strainer on said container body, distanced a pre-selected distance from said strainer so as to delimit a pre-defined volume therebetween.

20. The method according to claim 15, wherein said step of disposing a lid includes disposing a lid having an adjustment mechanism.

21. The container according to claim 4, wherein said at least one upstanding ridge is disposed on said support member.
